(19) United States
(12) Patent Application Publication
(10) Pub. No.: US 2023/0178081 A1
(43) Pub. Date: Jun. 8, 2023

(54) DISPLAY CONTROL SYSTEM, DISPLAY CONTROL METHOD AND INFORMATION STORAGE MEDIUM

(71) Applicant: POCKETALK CORPORATION, Tokyo (JP)

(72) Inventors: Hajime KAWATAKE, Tokyo (JP); Tatsuya INOUE, Tokyo (JP)

(21) Appl. No.: 18/053,364

(22) Filed: Nov. 7, 2022

Related U.S. Application Data
(60) Provisional application No. 63/293,056, filed on Dec. 22, 2021.

(30) Foreign Application Priority Data
Dec. 8, 2021 (JP) 2021-199424

(51) Int. Cl. G10L 15/26; G10L 15/00; G06T 11/60; H04N 7/14

(52) U.S. Cl. CPC G10L 15/26; G10L 15/005; G06T 11/60; H04N 7/144; H04N 2007/145

(57) ABSTRACT

An input relay unit receives speech data indicating a speech entered by a speaker. An input relay unit receives a confirmation request that is output in response to a predetermined operation of the speaker. A character string relay unit controls translation of the speech indicated by the speech data, which has been received before the reception of the confirmation request, to be started in response to the reception of the confirmation request. A display control unit controls a display unit to display a screen including an image obtained by overlaying a character string representing a translation result of a speech indicated by speech data that has been received before the reception of the confirmation request on an image captured by a capturing unit.

### CROSS-REFERENCE TO RELATED APPLICATIONS

The present application claims priority from Japanese Patent Application JP 2021-199424 filed on Dec. 8, 2021 and U.S. Provisional Patent Application No. U.S. 63/293,056 filed on Dec. 22, 2021, the contents of which are hereby incorporated by reference into this application.

### BACKGROUND OF THE INVENTION

### 1. Field of the Invention

The present invention relates to a display control system, a display control method, and an information storage medium.

### 2. Description of the Related Art

There are techniques for displaying an image obtained by overlaying a character string representing a result of translation of a speech on an image captured by a capturing unit. As an example of such a technique, Japanese Patent Application Laid-open No. 2015-153408 A describes a video conference system for displaying a video signal of video data, in which character information obtained by translating speech data of a speaker is overlaid on a video signal that captures the speaker on a screen.

Further, there are techniques for starting translation of previously entered speech when the absence of input of recognizable speech continues a few seconds.

### SUMMARY OF THE INVENTION

In the technique described in Japanese Patent Application Laid-open No. 2015-153408 A, if the translation of previously entered speech is started when there has been no recognizable speech entered for several seconds, a certain amount of time is required between the input of the speech and displaying the translation result of the speech. As such, the participants of the video conference cannot grasp the translation result of the speech in a timely manner.

One or more embodiments of the present invention have been conceived in view of the above, and an object thereof is to provide a display control system, a display control method, and an information storage medium capable of displaying a result of translation of entered speech in a timely manner.

A display control system according to the present invention includes speech data receiving means for receiving speech data indicating a speech entered by a speaker, confirmation request receiving means for receiving a confirmation request that is output in response to a predetermined operation of the speaker, translation control means for controlling translation of the speech indicated by the speech data to be started in response to a reception of the confirmation request, the speech data having been received before the reception of the confirmation request, and translation result display control means for controlling a display unit to display a screen including an image obtained by overlaying a character string on an image captured by a capturing unit, the character string representing a translation result of the speech indicated by the speech data that has been received before the reception of the confirmation request.

In one aspect of the present invention, the display control system further includes speech recognition result display control means for controlling the display unit to display a screen including an image obtained by overlaying a character string on an image captured by the capturing unit, the character string representing a speech recognition result of a speech indicated by the speech data. The speech recognition result display control means controls the display unit to display, before the reception of the confirmation request, a screen including an image obtained by overlaying a character string on an image captured by the capturing unit, the character string representing a speech recognition result of the speech indicated by the received speech data.

In one aspect of the present invention, the translation result display control means controls the display unit to display a screen including an image obtained by overlaying both of a character string representing a speech recognition result of a speech indicated by the speech data that has been received before the reception of the confirmation request and a character string representing a translation result of the speech indicated by the speech data that has been received before the reception of the confirmation request on an image captured by the capturing unit.

In one aspect of the present invention, the display control system further includes an image output unit that outputs an image obtained by overlaying a character string on an image captured by the capturing unit, to a video conference system. The translation result display control means controls the display unit to display the screen generated by the video conference system.

In one aspect of the present invention, the speech data receiving means receives the speech data indicating a speech from a terminal, the speech being entered in the terminal by the speaker. The confirmation request receiving means receives the confirmation request transmitted from the terminal in response to a predetermined operation performed on the terminal by the speaker. The translation result display control means controls the display unit of the terminal to display a character string representing a translation result of the speech indicated by the speech data that has been received before the reception of the confirmation request. The translation result display control means controls a display unit of a client device to display a screen including an image obtained by overlaying a character string on an image captured by the capturing unit, the character string representing a translation result of a speech indicated by the speech data that has been received before the reception of the confirmation request.

Alternatively, the speech data receiving means receives the speech data indicating a speech from the client device, the speech being entered in the client device by the speaker. The confirmation request receiving means receives the confirmation request that is transmitted from the client device in response to a predetermined operation performed on the client device by the speaker. The translation result display control means controls the display unit of the client device to display a screen including an image obtained by overlaying a character string on an image captured by the capturing unit, the character string representing a translation result of a speech indicated by the speech data that has been received before the reception of the confirmation request.

In one aspect of the present invention, the translation control means controls translation of a speech indicated by the speech data into a plurality of languages to be started, the speech data having been received before the reception of the confirmation request, and the translation result display control means controls the display unit to display a screen including an image obtained by overlaying character strings on an image captured by the capturing unit, the character strings representing translation results of the speech indicated by the speech data in the plurality of languages.

A display control method according to the present invention includes the steps of receiving speech data indicating a speech entered by a speaker, receiving a confirmation request that is output in response to a predetermined operation of the speaker, controlling translation of the speech indicated by the speech data to be started in response to a reception of the confirmation request, the speech data having been received before the reception of the confirmation request, and controlling a display unit to display a screen including an image obtained by overlaying a character string on an image captured by a capturing unit, the character string representing a translation result of the speech indicated by the speech data that has been received before the reception of the confirmation request.

A non-transitory computer readable information storage medium storing a program according to the present invention causes a computer to execute the steps of receiving speech data indicating a speech entered by a speaker, receiving a confirmation request that is output in response to a predetermined operation of the speaker, controlling translation of the speech indicated by the speech data to be started in response to a reception of the confirmation request, the speech data having been received before the reception of the confirmation request, and controlling a display unit to display a screen including an image obtained by overlaying a character string on an image captured by a capturing unit, the character string representing a translation result of the speech indicated by the speech data that has been received before the reception of the confirmation request.

### BRIEF DESCRIPTION OF THE DRAWINGS

FIG. 1 is a diagram illustrating an example of an overall configuration of a video conference translating system according to an embodiment of the present invention;

FIG. 2 is a diagram illustrating an example of a back surface of a terminal according to an embodiment of the present invention;

FIG. 3A is a diagram illustrating an example of a configuration of the terminal according to an embodiment of the present invention;

FIG. 3B is a diagram illustrating an example of a configuration of a client device according to an embodiment of the present invention;

FIG. 3C is a diagram illustrating an example of a configuration of a relay device according to an embodiment of the present invention;

FIG. 3D is a diagram illustrating an example of a configuration of a speech processing system according to an embodiment of the present invention;

FIG. 4 is a diagram illustrating an example of a video conference screen;

FIG. 5 is a diagram illustrating an example of a speech recognition result image;

FIG. 6 is a diagram illustrating an example of a video conference screen;

FIG. 7 is a diagram illustrating an example of a translation result image;

FIG. 8A is a functional block diagram showing an example of functions implemented by the terminal, the relay device, and the speech processing system according to an embodiment of the present invention;

FIG. 8B is a functional block diagram showing an example of functions implemented by the client device according to an embodiment of the present invention;

FIG. 9 is a flow chart showing an example of processing performed in the relay device according to an embodiment of the present invention;

FIG. 10 is a flow chart showing an example of processing performed in the relay device according to an embodiment of the present invention;

FIG. 11 is a flow chart showing an example of processing performed in the client device according to an embodiment of the present invention;

FIG. 12 is a diagram illustrating an example of a video conference screen; and

FIG. 13 is a diagram illustrating an example of a configuration of the client device according to a modification of the embodiment of the present invention.

### DETAILED DESCRIPTION OF THE INVENTION

An embodiment of the present invention will be described below with reference to the accompanying drawings.

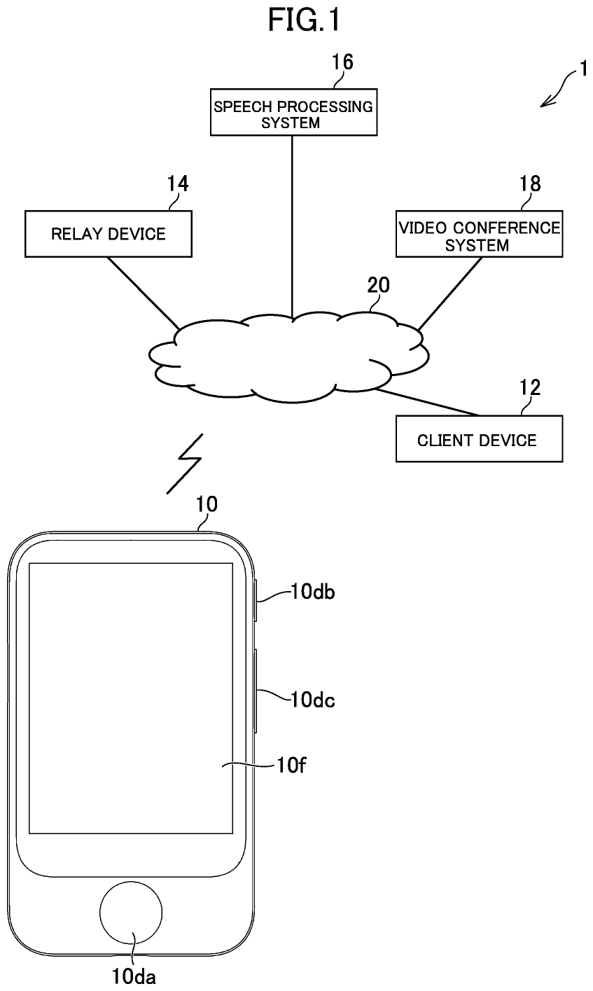

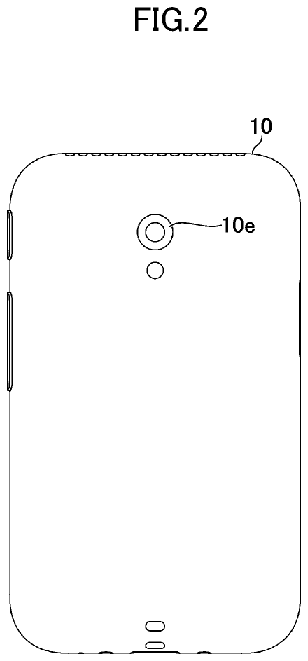

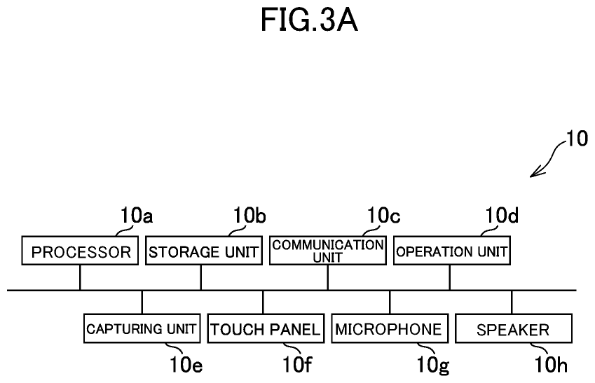

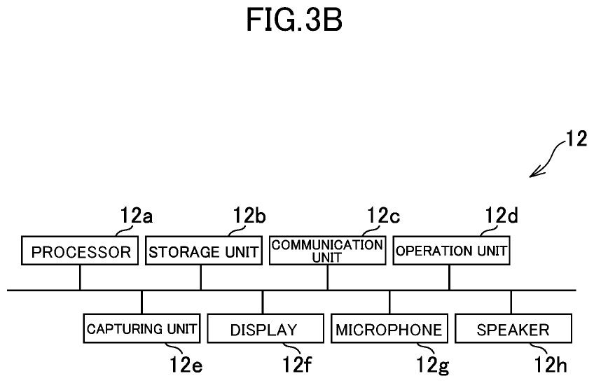

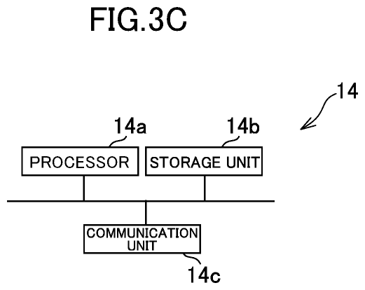

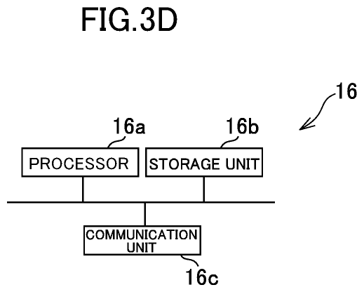

FIG. 1 is a diagram illustrating an example of an overall configuration of a video conference translating system 1 according to the present embodiment. FIG. 2 is a diagram illustrating an example of a rear surface of a terminal 10 according to the present embodiment. FIG. 3A is a diagram illustrating an example of a configuration of the terminal 10 according to the present embodiment. FIG. 3B is a diagram illustrating an example of a configuration of a client device 12 according to the present embodiment. FIG. 3C is a diagram illustrating an example of a configuration of a relay device 14 according to the present embodiment. FIG. 3D is a diagram illustrating an example of a configuration of a speech processing system 16 according to the present embodiment.

As shown in FIG. 1, the video conference translating system 1 according to the present embodiment includes the terminal 10, the client device 12, the relay device 14, the speech processing system 16, and a video conference system 18. The terminal 10, the client device 12, the relay device 14, the speech processing system 16, and the video conference system 18 are connected to a computer network 20 such as the Internet. As such, the terminal 10, the client device 12, the relay device 14, the speech processing system 16, and the video conference system 18 can communicate with each other via the computer network 20. The terminal 10 according to the present embodiment is a computer used by a user participating in a video conference. As shown in FIG. 3A, the terminal 10 according to the present embodiment includes, for example, a processor 10a, a storage unit 10b, a communication unit 10c, an operation unit 10d, a capturing unit 10e, a touch panel 10f, a microphone 10g, and a speaker (a speaker device) 10h.

The processor 10a is, for example, a program control device, such as a microprocessor, operating in accordance with a program installed in the terminal 10.

The storage unit 10b is, for example, a storage element such as a ROM or a RAM. The storage unit 10b stores a program to be executed by the processor 10a.

The communication unit 10c is a communication interface for transferring data to and from the relay device 14 via the computer network 20, for example. The communication unit 10c may include a wireless communication module that communicates with the computer network 20 such as the Internet through a mobile telephone line including a base station. The communication unit 10c may also include a wireless LAN module for communicating with the computer network 20 such as the Internet via a Wi-Fi (trademark) router, for example.

The operation unit 10d is an operation member, such as a button and a touch sensor, for outputting an operation performed by the user to the processor 10a, for example. In FIG. 1, examples of the operation unit 10d are shown as a translation button 10da that is pressed when inputting a speech to be translated, a power button 10db for turning the power on and off, and a volume adjusting unit 10dc for adjusting the volume of the speech from the speaker 10h. The translation button 10da is disposed below the touch panel 10f provided on the front surface of the terminal 10. The power button 10db and the volume adjusting unit 10dc are disposed on the right side of the terminal 10.

The capturing unit 10e is a capturing device such as a digital camera. As shown in FIG. 2, the terminal 10 according to the present embodiment includes the capturing unit 10e on the back.

Touch panel 10f is formed by integrating a touch sensor and a display, such as a liquid crystal display and an organic EL display. The touch panel 10f is provided on the front surface of the terminal 10 and displays a screen generated by the processor 10a, for example.

The microphone 10g is, for example, a speech input device that converts the received speech into an electric signal. The microphone 10g may be a dual microphone built in the terminal 10 and having a noise canceling function for easy recognition of human voices in a crowded place.

The speaker 10h is an audio output device that outputs speech, for example. The speaker 10h may be a dynamic speaker that is built in the terminal 10 and usable in a noisy place.

The client device 12 according to the present embodiment is a typical computer such as a smart phone, a tablet terminal, and a personal computer. As shown in FIG. 3B, the client device 12 according to the present embodiment includes, for example, a processor 12a, a storage unit 12b, a communication unit 12c, an operation unit 12d, a capturing unit 12e, a display 12f, a microphone 12g, and a speaker (a speaker device) 12h.

The client device 12 according to the present embodiment is used by a user who uses the terminal 10 when a video conference is held. That is, in the present embodiment, the user of the terminal 10 is the same as the user of the client device 12.

The processor 12a is, for example, a program control device such as a CPU that operates in accordance with a program installed in the client device 12.

The storage unit 12b is, for example, a storage element such as a ROM and a RAM, a solid state drive, and a hard disk drive. The storage unit 12b stores a program to be executed by the processor 12a.

The communication unit 12c is, for example, a communication interface such as a network board and a wireless LAN module. The communication unit 12c transmits and receives data to and from the relay device 14 and the video conference system 18 via the computer network 20, for example.

The operation unit 12d is a user interface, such as a keyboard and a mouse, which receives an operation of the user and outputs a signal indicating the operation to the processor 12a.

The capturing unit 12e is a capturing device such as a digital video camera. The capturing unit 12e is disposed in a position capable of capturing a user of the client device 12. The capturing unit 12e according to the present embodiment can capture a video image.

The display 12f is, for example, a display device such as a liquid crystal display and an organic EL display, and displays various images in accordance with instructions from the processor 12a.

The microphone 12g is, for example, a speech input device that converts received speech into an electric signal.

The speaker 12h is an audio output device that outputs speech, for example.

In the present embodiment, the relay device 14 is a computer system such as a server computer that relays speech data representing a speech entered in the terminal 10, a speech recognition result character string representing a speech recognition result of the speech, and a translation result character string representing a translation result of the speech, for example. The video conference translating system 1 may include one relay device 14 or a plurality of relay devices 14. As shown in FIG. 3C, the relay device 14 according to the present embodiment includes, for example, a processor 14a, a storage unit 14b, and a communication unit 14c.

The processor 14a is, for example, a program control device such as a CPU that operates in accordance with a program installed in the relay device 14.

The storage unit 14b is, for example, a storage element such as a ROM and a RAM, a solid state drive, and a hard disk drive. The storage unit 14b stores a program to be executed by the processor 14a.

The communication unit 14c is a communication interface such as a network board. The communication unit 14c transmits and receives data to and from the terminal 10, the client device 12, and the speech processing system 16 via the computer network 20, for example.

The speech processing system 16 is a computer system such as a server computer that executes speech recognition of a speech indicated by the received speech data and speech processing such as translation of the speech. The speech processing system 16 may be composed of one computer or a plurality of computers. As shown in FIG. 3D, the speech processing system 16 according to the present embodiment includes, for example, a processor 16a, a storage unit 16b, and a communication unit 16c.

The processor 16a is, for example, a program control device such as a CPU that operates in accordance with a program installed in the speech processing system 16.

The storage unit 16b is, for example, a storage element such as a ROM and a RAM, a solid state drive, and a hard disk drive. The storage unit 16b stores a program to be executed by the processor 16a.

The communication unit 16c is a communication interface such as a network board. The communication unit 16c transfers data to and from the relay device 14 via the computer network 20, for example.

The video conference system 18 is a typical video conference system for providing a video conference by a plurality of participants, for example. In the present embodiment, for example, assume that client software that is related to the video conference system 18 and operates in cooperation with the video conference system 18 is installed in the client device 12.

In the present embodiment, a video conference with multiple participants including the users of the terminal 10 and the client device 12 is held in advance by the functions of the video conference system 18.

In the present embodiment, a predetermined operation is performed on the terminal 10 by the user in advance, thereby setting a pre-translation language, which is a language of a speech entered into the terminal 10, and a post-translation language, which is a language to which the speech is translated. In the following, assume that Japanese is set as the pre-translation language and English is set as the post-translation language.

In the present embodiment, the speech recognition processing is performed on a speech entered through the microphone 10g during a period from when the user presses a predetermined button (e.g., translation button 10da) provided in the terminal 10 with a finger until when the user releases the finger from the button. When the user releases the finger from the translation button 10da, the translation processing is performed on a speech entered through the microphone 10g during a period from when the user presses the translation button 10da with the finger until when the user releases the finger from the translation button 10da. Hereinafter, a state in which the translation button 10da is pressed is referred to as an input-on state, and a state in which the translation button 10da is not pressed is referred to as an input-off state.

In the present embodiment, for example, while the input-on state continues, the speech recognition processing is successively executed on a speech entered during a period from the time when the input-off state is changed to the input-on state to the present time. Subsequently, a speech recognition result character string, which is a character string indicating the speech recognition result of the speech, is displayed on the display 12f of the client device 12 and also on the touch panel 10f of the terminal 10.

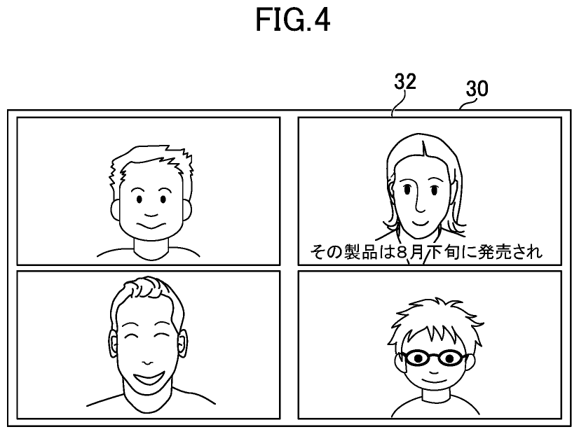

FIG. 4 is a diagram illustrating an example of a video conference screen 30, which is a screen of a video conference displayed on the display 12f of the client device 12. As shown in FIG. 4, in the present embodiment, for example, the display 12f displays the video conference screen 30 including an overlay image 32 in which a speech recognition result character string is overlaid on a captured image of a user who has entered a speech into the terminal 10. The captured image according to the present embodiment is, for example, an image captured by the capturing unit 12e. The captured image according to the present embodiment may be an image captured by the capturing unit 10e.

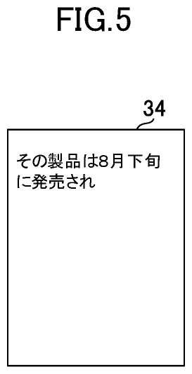

FIG. 5 is a diagram showing an example of a speech recognition result image 34 displayed on the touch panel 10f of the terminal 10. As shown in FIG. 5, in the present embodiment, the same character string as the character string disposed on the video conference screen 30 shown in FIG. 4 is also disposed on the speech recognition result image 34.

In the present embodiment, as described above, while the terminal 10 is in the input-on state, the speech recognition processing is sequentially executed on a speech entered in a period from the time when the terminal 10 is changed from the input-off state to the input-on state to the present time. Each time the speech recognition processing is executed, the speech recognition result character string displayed on the touch panel 10f and the display 12f is updated.

When the user releases the finger from the translation button 10da and the terminal 10 is in the input-off state, the terminal 10 sends a confirmation request to the relay device 14. The final speech recognition processing is then executed on the speech entered while the terminal 10 is in the input-on state. Subsequently, the translation processing is executed on the speech recognition result character string indicating the result of the speech recognition processing, and the translation result character string is generated by translating the speech recognition result character string. Here, for example, a translation result string, which is an English character string obtained by translating the speech recognition result character string, which is a Japanese character string, is generated.

The speech recognition character string and the translation result character string that are generated in this manner are displayed on the display 12f of the client device 12 and also on the touch panel 10f of the terminal 10.

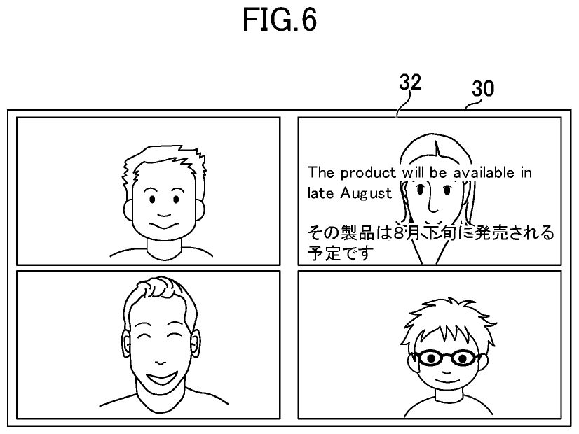

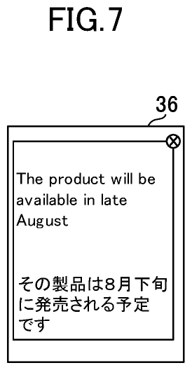

For example, as shown in FIG. 6, the display 12f displays the video conference screen 30 including the overlay image 32 in which the speech recognition result character string and the translation result character string are overlaid on the captured image of the user who has entered a speech into the terminal 10. Further, as shown in FIG. 7, the touch panel 10f displays a translation result image 36 including the same character string as the speech recognition result character string disposed on the video conference screen 30 shown in FIG. 6 and the same character string as the translation result character string disposed on the video conference screen 30 shown in FIG. 6.

For convenience of explanation, FIG. 6 shows the video conference screen 30 in which the translation result character string is easily visible. However, in practice, the translation result character string on display has been difficult to see depending on the background image of the screen in which the translation result character string is disposed (e.g., captured image), and the user who is the speaker (the user who makes a speech) may not be able to accurately grasp the translation result.

In this embodiment, as shown in FIG. 7, the touch panel 10f of the terminal 10 displays the translation result image 36 including the same character string as the translation result character string shown in FIG. 6.

In this manner, according to the present embodiment, the user can accurately grasp the translated result of the speech entered by the user.

For convenience of explanation, FIGS. 4 and 6 show the video conference screen 30 in which the speech recognition result character string is easily visible. However, in practice, the speech recognition result character string on display has been difficult to see depending on the background image of the screen in which the speech recognition result character string is disposed (e.g., captured image), and the user who is the speaker may not be able to accurately grasp the speech recognition result.

In this embodiment, as shown in FIG. 5, the touch panel 10f of the terminal 10 displays the speech recognition result image 34 including the same character string as the speech recognition result character string shown in FIG. 4. Further, as shown in FIG. 7, the touch panel 10f of the terminal 10 displays the translation result image 36 including the same character string as the speech recognition result character string shown in FIG. 6.

In this manner, according to the present embodiment, the user can accurately grasp the speech recognition result of the speech entered by the user.

In the present embodiment, when the relay device 14 receives a confirmation request, the translation of the speech indicated by the speech data received before the acceptance of such a confirmation request is started. In this manner, it is possible to shorten the period of time from the input of a speech to the translation of the speech as compared with the case where the translation of the speech entered so far is started when a recognizable speech is not entered for a few seconds. In this manner, according to the present embodiment, the translation result of the entered speech can be displayed in a timely manner.

In the following, functions of the video conference translating system 1 according to the present embodiment and the processing executed by the video conference translation system 1 will be further described.

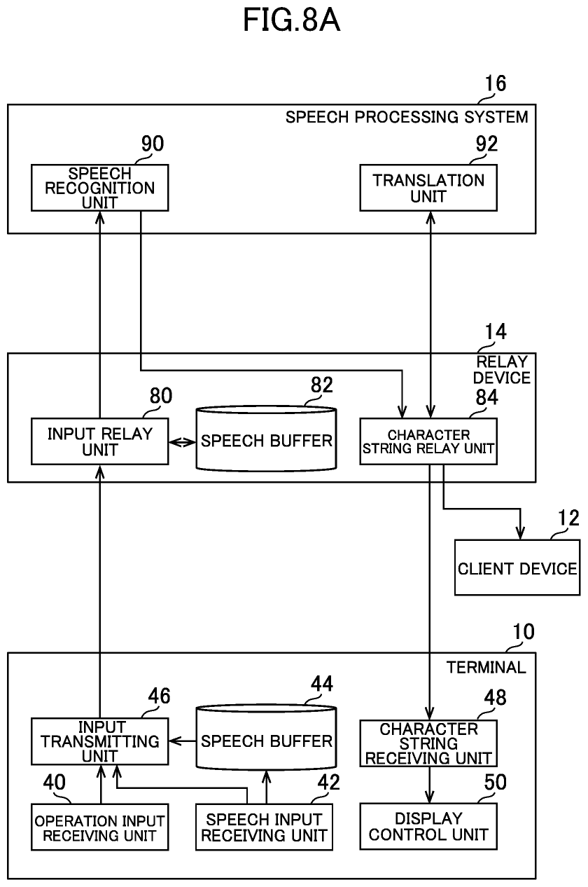

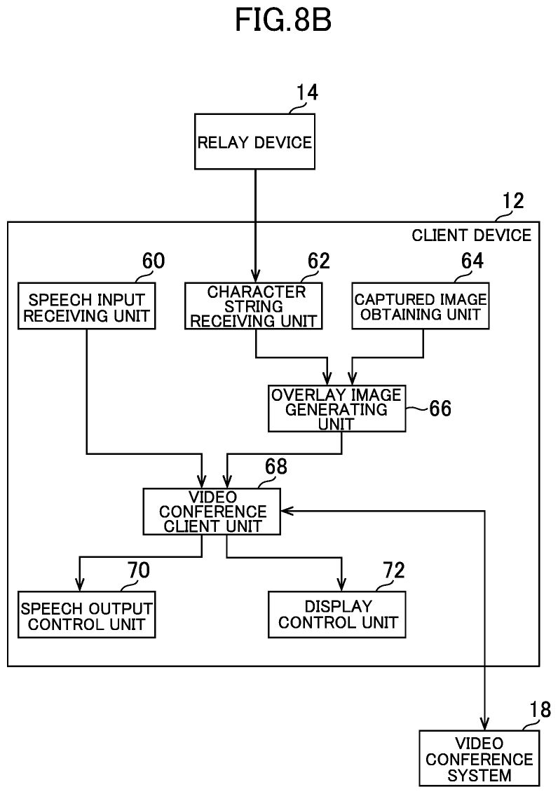

FIG. 8A is a functional block diagram showing an example of functions implemented by the terminal 10, the relay device 14, and the speech processing system 16 according to the present embodiment. FIG. 8B is a functional block diagram showing an example of functions implemented by the client device 12 according to the present embodiment.

In the terminal 10, the relay device 14, and the speech processing system 16 according to the present embodiment, all of the functions shown in FIG. 8A need not be implemented, and functions other than the functions shown in FIG. 8A may be implemented. In the client device 12 according to the present embodiment, all of the functions shown in FIG. 8B need not be implemented, and functions other than the functions shown in FIG. 8B may be implemented.

As shown in FIG. 8A, the terminal 10 according to the present embodiment functionally includes, for example, an operation input receiving unit 40, a speech input receiving unit 42, a speech buffer 44, an input transmitting unit 46, a character string receiving unit 48, and a display control unit 50. The operation input receiving unit 40 is implemented mainly by a processor 10a, an operation unit 10d, and a touch panel 10f. The speech input receiving unit 42 is implemented mainly by the processor 10a and a microphone 10g. The speech buffer 44 is implemented mainly by a storage unit 10b. The input transmitting unit 46 and the character string receiving unit 48 are mainly implemented by a communication unit 10c. The display control unit 50 is mainly implemented by the processor 10a and the touch panel 10f.

The functions described above are implemented when the processor 10a executes a program that is installed in the user terminal 10, which is a computer, and includes commands corresponding to the above functions. The program is supplied to the user terminal 10 via a computer-readable information storage medium, such as an optical disk, a magnetic disk, a magnetic tape, and a magneto-optical disk, or the Internet.

As shown in FIG. 8B, the client device 12 according to the present embodiment functionally includes, for example, a speech input receiving unit 60, a character string receiving unit 62, a captured image obtaining unit 64, an overlay image generating unit 66, a video conference client unit 68, a speech output control unit 70, and a display control unit 72. The speech input receiving unit 60 is implemented mainly by a processor 12a and a microphone 12g. The character string receiving unit 62 is implemented mainly by a communication unit 12c. The captured image obtaining unit 64 is implemented mainly by the processor 12a and a capturing unit 12e. The overlay image generating unit 66 is mainly implemented by the processor 12a. The video conference client unit 68 is implemented mainly by the processor 12a and the communication unit 12c. The speech output control unit 70 is implemented mainly by the processor 12a and a speaker 12h. The display control unit 72 is implemented mainly by the processor 12a and the display 12f.

The functions described above are implemented when the processor 12a executes a program that is installed in the client device 12, which is a computer, and includes commands corresponding to the above functions. The program is supplied to the client device 12 via a computer-readable information storage medium such as an optical disk, a magnetic disk, a magnetic tape, a magneto-optical disk, a flash memory, or via the Internet, for example.

As shown in FIG. 8A, the relay device 14 according to the present embodiment functionally includes, for example, an input relay unit 80, a speech buffer 82, and a character string relay unit 84. The input relay unit 80 and the character string relay unit 84 are mainly implemented by a communication unit 14c. The speech buffer 82 is implemented mainly by the storage unit 14b.

The functions described above are implemented when the processor 14a executes a program that is installed in the relay device 14, which is a computer, and includes commands corresponding to the above functions. The program is supplied to the relay device 14 via a computer-readable information storage medium, such as an optical disk, a magnetic disk, a magnetic tape, and a magneto-optical disk, or the Internet, for example.

As shown in FIG. 8A, the speech processing system 16 according to the present embodiment functionally includes, for example, a speech recognition unit 90 and a translation unit 92. The speech recognition unit 90 and the translation unit 92 are implemented mainly by the processor 16a and the communication unit 16c.

The functions described above are implemented when the processor 16a executes a program that is installed in the speech processing system 16, which is a computer, and includes commands corresponding to the above functions. The program is supplied to the speech processing system 16 via a computer-readable information storage medium, such as an optical disk, a magnetic disk, a magnetic tape, and a magneto-optical disk, or the Internet.

In the present embodiment, the operation input receiving unit 40 of the terminal 10 receives an operation input to the terminal 10, such as an operation of the user to press the translation button 10da with a finger and an operation of the user to release the finger from the translation button 10da.

In this embodiment, for example, the speech input receiving unit 42 of the terminal 10 receives a speech entered by a speaker (a man or a woman who makes a speech) via the microphone 10g while the terminal 10 is in the input-on state.

For example, in the present embodiment, the speech buffer 44 of the terminal 10 stores speech data indicating a speech entered through the microphone 10g.

For example, in the present embodiment, the input transmitting unit 46 of the terminal 10 transmits an operation signal corresponding to an operation input received by the operation input receiving unit 40 to the relay device 14.

For example, in the present embodiment, the input transmitting unit 46 transmits speech data indicating a speech entered in the terminal 10 to the relay device 14.

For example, in this embodiment, the input transmitting unit 46 transmits a communication start request to the relay device 14 in response to the terminal 10 changing from the input-off state to the input-on state. The speech buffer 44 then stores the speech data indicating the speech entered via the microphone 10g during the period from the time when the terminal 10 changes from the input-off state to the input-on state to the time when the communication between the relay device 14 and the terminal 10 is established.

When the communication between the relay device 14 and the terminal 10 is established (i.e., the terminal 10 is connected to the relay device 14), the input transmitting unit 46 transmits the speech data stored in the speech buffer 44 to the relay device 14. Generally, for example, the speech data stored in the speech buffer 44 indicating the speech of a length of two seconds is transmitted in about 0.1 seconds.

After all of the speech data stored in the speech buffer 44 is transmitted to the relay device 14, while the terminal 10 is in the input-on state, the input transmitting unit 46 transmits a stream of packets of speech data indicating the speech received by the speech input receiving unit 42 to the relay device 14. In this case, the packet of speech data is transmitted directly to the relay device 14 in real time without being stored in the speech buffer 44. The packet of speech data may include pre-translation language data indicating a pre-translation language and post-translation language data indicating a post-translation language.

In this embodiment, for example, the input relay unit 80 of the relay device 14 receives speech data transmitted from the input transmitting unit 46. The input relay unit 80 transmits the received speech data to the speech recognition unit 90 of the speech processing system 16. For example, the input relay unit 80 receives a stream of packets of speech data transmitted from the input transmitting unit 46 and transmits the received packets to the speech recognition unit 90 of the speech processing system 16.

In the present embodiment, the speech processing system 16 may include a plurality of speech recognition units 90 associated with different languages. The input relay unit 80 may transmit the received speech data to the speech recognition unit 90 associated with the post-translation language.

In this embodiment, when receiving a packet from the input transmitting unit 46, the input relay unit 80 temporarily stores the packet in the speech buffer 82. The input relay unit 80 transmits the packet stored in the speech buffer 82 to the speech recognition unit 90 of the speech processing system 16. In this manner, even if a communication error occurs between the speech processing system 16 and the relay device 14, it is possible to retry the transmission of the packet.

For example, in the present embodiment, the speech recognition unit 90 of the speech processing system 16 receives a packet of speech data from the input relay unit 80 of the relay device 14.

For example, in the present embodiment, the speech recognition unit 90 of the speech processing system 16 executes speech recognition processing on the speech indicated by the received speech data and generates a speech recognition result character string representing the speech recognition result of the speech. For example, each time the speech recognition unit 90 receives a packet of speech data, the speech recognition unit 90 may execute the speech recognition processing on the speech data received in the period from the time when the terminal 10 is connected to the relay device 14 until when the packet is received to generate the speech recognition result character string.

For example, in the present embodiment, the speech recognition unit 90 of the speech processing system 16 transmits the speech recognition result character string generated by the speech recognition unit 90 to the relay device 14. In a case where the speech recognition processing is sequentially executed, each time a speech recognition result character string is generated, the generated speech recognition result character string may be transmitted to the relay device 14.

For example, in this embodiment, the character string relay unit 84 of the relay device 14 receives the speech recognition result character string described above.

In response to the change of the terminal 10 from the input-on state to the input-off state, the input transmitting unit 46 transmits a confirmation request to the relay device 14. If there is speech data stored in the speech buffer 44 at the time when the input-on state is changed to the input-off state, the input transmitting unit 46 transmits the speech data stored in the speech buffer 44 to the relay device 14 and then transmits a confirmation request to the relay device 14. If there is no speech data stored in the speech buffer 44 at the time when the input-on state is changed to the input-off state, the input transmitting unit 46 immediately transmits a confirmation request to the relay device 14. Generally, when the input-on state is changed to the input-off state, there is often no speech data stored in the speech buffer 44, and almost all of the speech data is already transmitted at the time when the input-on state is changed to the input-off state.

In the present embodiment, if a speech is entered in the terminal 10 for a predetermined period of time (e.g., 30 seconds), the reception of the speech may be terminated at that time, and a confirmation request may be transmitted.

For example, in the present embodiment, the input relay unit 80 of the relay device 14 receives a confirmation request that is output in response to a predetermined operation (e.g., an operation of releasing a finger from the translating button 10da) performed by the speaker. For example, the input relay unit 80 of the relay device 14 receives a confirmation request that is transmitted from the input transmitting unit 46 when the speaker releases the finger from the translation button 10da.

In the present embodiment, for example, in response to the input relay unit 80 receiving a confirmation request, the character string relay unit 84 of the relay device 14 controls translation of the speech indicated by the speech data received before the reception of the confirmation request to be started. For example, in response to the input relay unit 80 receiving a confirmation request, the character string relay unit 84 of the relay device 14 transmits, to the translation unit 92 of the speech processing system 16, the speech recognition character string representing the speech recognition result of the speech indicated by the speech data received in the period from the time when the terminal 10 is connected to the relay device 14 until when the confirmation request is received.

In the present embodiment, the speech processing system 16 may include a plurality of translation units 92 associated with different languages. The character string relay unit 84 may transmit the speech recognition character string to the translation unit 92 associated with the post-translation language.

For example, in the present embodiment, the translation unit 92 of the speech processing system 16 receives a speech recognition result character string transmitted by the character string relay unit 84. The translation unit 92 of the speech processing system 16 executes translation processing on the received speech recognition result character string. Subsequently, the translation unit 92 generates a translation result character string representing the result of the translation processing.

For example, in this embodiment, the translation unit 92 transmits the translation result character strings generated as described above to the relay device 14.

For example, in this embodiment, the character string relay unit 84 of the relay device 14 transmits the speech recognition result character string representing the speech recognition result of the speech indicated by the speech data to both the communication unit 10c of the terminal 10 and the communication unit 12c of the client device 12. For example, upon receiving the speech recognition result character string from the speech recognition unit 90 of the speech processing system 16, the character string relay unit 84 transmits the speech recognition character string to both the terminal 10 and the client device 12.

For example, in this embodiment, the character string relay unit 84 of the relay device 14 transmits the translation result character string representing the translation result of the speech indicated by the speech data to both the communication unit 10c of the terminal 10 and the communication unit 12c of the client device 12. For example, upon receiving a translation result character string from the translation unit 92 of the speech processing system 16, the character string relay unit 84 transmits the received translation result character string to both the terminal 10 and the client device 12.

For example, in the present embodiment, the character string receiving unit 48 of the terminal 10 receives a speech recognition result character string from the relay device 14.

For example, in the present embodiment, the character string receiving unit 48 of the terminal 10 receives a translation result character string from the relay device 14.

For example, the display control unit 50 of the terminal 10 controls the display unit (e.g., the touch panel 10f) of the terminal 10 to display the speech recognition result character string received by the character string receiving unit 48. For example, the display control unit 50 controls the display unit (e.g., the touch panel 10f) of the terminal 10 to display the translation result character string received by the character string receiving unit 48.

As shown in FIG. 7, the display control unit 50 may generate a translation result image 36 in which both the speech recognition result character string and the translation result character string received by the character string receiving unit 48 are disposed. The display control unit 50 may controls the touch panel 10f to display the translation result image 36.

In the present embodiment, the display control unit 50 may control the touch panel 10f to display a character string, which is received by the character string receiving unit 48, in a color different from that of the single-color background. In this manner, a user can more accurately grasp the translation result and the speech recognition result of the speech entered by the user.

For example, in this embodiment, the speech input receiving unit 60 of the client device 12 receives a speech of the user entered via the microphone 12g. Subsequently, the speech input receiving unit 60 outputs the speech data indicating the entered speech to the video conference client unit 68.

For example, in the present embodiment, the character string receiving unit 62 of the client device 12 receives a speech recognition result character string from the relay device 14.

For example, in the present embodiment, the character string receiving unit 62 of the client device 12 receives a translation result character string from the relay device 14.

For example, in the present embodiment, the captured image obtaining unit 64 obtains a captured image captured by the capturing unit 12e.

For example, in the present embodiment, the overlay image generating unit 66 generates an overlay image 32, which is an image obtained by overlaying the speech recognition result character string received by the character string receiving unit 62 on the captured image described above. For example, in the present embodiment, the overlay image generating unit 66 generates an overlay image 32, which is an image obtained by overlaying the translation result character string received by the character string receiving unit 62 on the captured image described above.

As shown in FIG. 6, the overlay image generating unit 66 may generate an overlay image 32, which is an image obtained by overlaying both the translation result character string and the speech recognition result character string received by the character string receiving unit 62 on the captured image described above.

For example, in this embodiment, the overlay image generating unit 66 outputs the generated overlay image 32 to the video conference client unit 68.

For example, in this embodiment, the video conference client unit 68 of the client device 12 functions in cooperation with the video conference system 18 to execute various processes related to the video conference.

For example, the video conference client unit 68 may output an overlay image 32 in which the character string received by the character string receiving unit 62 is overlaid on the above-described captured image to the video conference system 18. For example, the video conference client unit 68 may output the overlay image 32 received from the overlay image generating unit 66 to the video conference system 18.

For example, the video conference client unit 68 may also output the speech data received from the speech input receiving unit 60 to the video conference system 18.

For example, in this embodiment, the video conference client unit 68 outputs the video conference screen 30, which is generated by the video conference system 18 and shown in FIGS. 4 and 6, to the display control unit 72.

For example, in this embodiment, the video conference client unit 68 outputs speech data, which is generated by the video conference system 18 and represents a speech of the speaker in the video conference, to the speech output control unit 70.

For example, in this embodiment, the speech output control unit 70 of the client device 12 outputs, from the speaker 12h, the speech indicated by the speech data received from the video conference client unit 68.

For example, in this embodiment, the display control unit 72 of the client device 12 controls the display 12f to display a screen including an image obtained by overlaying a character string representing the speech recognition result of the speech indicated by speech data on an image captured by the capturing unit 12e. Prior to receiving the confirmation request, the display control unit 72 may control the display 12f to display a screen including the image obtained by overlaying the character string representing the speech recognition result of the speech indicated by the received speech data on the image captured by the capturing unit 12e. For example, the display control unit 72 of the client device 12 controls the display 12f of the client device 12 to display a screen including the image obtained by overlaying the character recognition result character string received by the character string receiving unit 62 on the captured image described above.

For example, in the present embodiment, the display control unit 72 controls the display 12f to display a screen including an image obtained by overlaying a character string representing the translation result of the speech indicated by the speech data received before the reception of the confirmation request on the image captured by the capturing unit 12e. For example, the display control unit 72 of the client device 12 controls the display 12f of the client device 12 to display a screen including an image obtained by overlaying the translation result character string received by the character string receiving unit 62 on the captured image described above.

As shown in FIG. 6, the display control unit 72 may control the display 12f to display the video conference screen 30 including the overlay image 32 obtained by overlaying both the translation result character string and the speech recognition result character string received by the character string receiving unit 62 on the captured image described above.

The display control unit 72 may also control the display 12f to display a screen generated by the video conference system 18. For example, the display control unit 72 may control the display 12f to display the video conference screen 30 received from the video conference client unit 68.

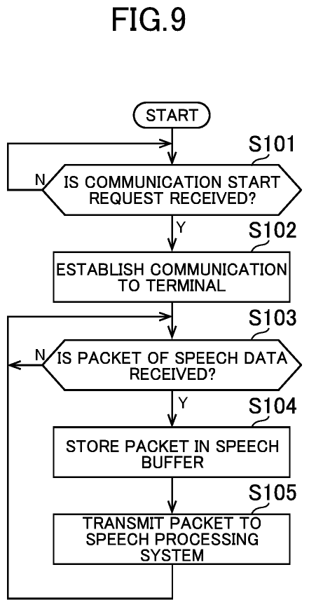

Referring to a flow chart shown in FIG. 9, an example of the relay processing of speech data to be executed by the relay device 14 will be described.

In this example of the processing, the input relay unit 80 monitors the reception of a communication start request from the input transmitting unit 46 of the terminal 10 (S101).

Upon receiving a communication start request from the input transmitting unit 46 of the terminal 10, the input relay unit 80 establishes communication between the relay device 14 and the terminal 10 (S102).

The input relay unit 80 monitors reception of a packet of speech data (S103). Upon receiving a packet of speech data, the input relay unit 80 stores the received packet in the speech buffer 82 (S104).

The input relay unit 80 transmits the packet stored in the speech buffer 82 in the processing shown in S104 to the speech recognition unit 90 of the speech processing system 16, and the processing returns to S103.

The processing shown in S103 to S105 is repeated until the processing shown in S207 described later is executed.

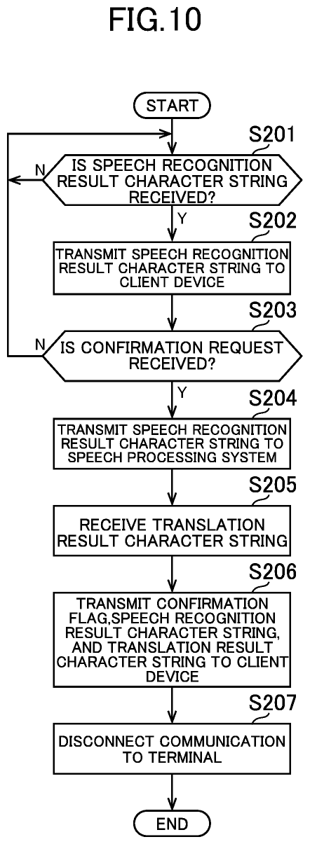

Next, referring to a flow chart shown in FIG. 10, an example of the relay processing of a character string to be executed by the relay device 14 will be described.

In this example of the processing, the character string relay unit 84 monitors reception of a speech recognition result character string from the speech recognition unit 90 of the speech processing system 16 (S201). Upon receiving a speech recognition result character string, the character string relay unit 84 transmits the received speech recognition result character string to the character string receiving unit 62 of the client device 12 (S202).

Subsequently, the character string relay unit 84 checks whether the input relay unit 80 has received a confirmation request (S203). If the reception of the confirmation request is not confirmed (S203:N), the processing returns to S201. If the reception of the confirmation request is confirmed (S203:Y), the character string relay unit 84 transmits the speech recognition result character string representing the speech recognition result of the speech indicated by the speech data received before the reception of the confirmation request to the translation unit 92 of the speech processing system 16 (S204).

The character string relay unit 84 then receives a translation result character string, which is obtained by translating the speech recognition result character string transmitted in the processing shown in S203 from the translation unit 92 of the speech processing system 16 (S205).

The character string relaying unit 84 transmits a confirmation flag, the translation result character string received in the processing in S205, and the speech recognition result character string representing the speech recognition result of the speech indicated by the speech data received before the reception of the confirmation request to the character string receiving unit 62 of the client device 12 (S206).

The character string relay unit 84 disconnects the communication between the relay device 14 and the terminal 10 (S207), and the processing shown in this example is terminated. When the processing shown in S207 is executed, the processing shown in S103 to S105 is also terminated.

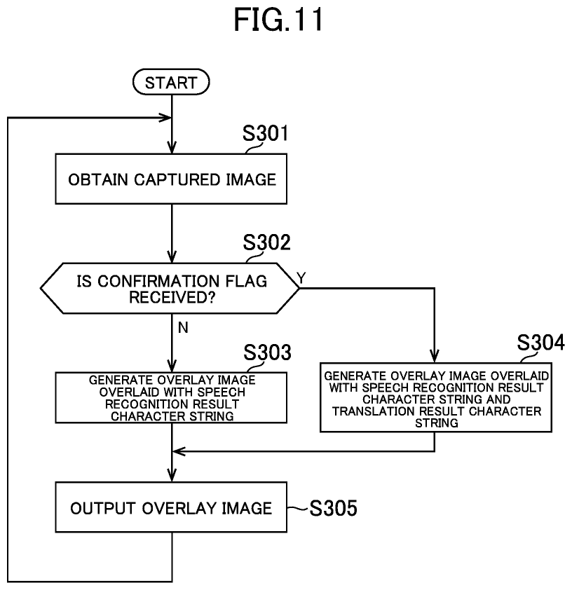

Next, referring to a flow chart shown in FIG. 11, an example of the processing of generating an overlay image 32 executed by the client device 12 will be described. In this example of the processing, the processing shown in S301 to S305 to be described below is repeatedly executed at a frame rate at which the capturing unit 12e captures images. For example, in the present embodiment, the processing shown in S301 to S305 may be executed at intervals of 1/30 second. The processing shown in S301 to S305 may be executed at intervals longer (or shorter) than1/30 second. Further, the execution interval may be adjustable by the user.

First, the captured image obtaining unit 64 obtains a captured image in the frame (S301).

The overlay image generating unit 66 checks whether the character string receiving unit 62 receives a confirmation flag after the processing shown in S202 is previously executed (S302).

If it is confirmed that the confirmation flag has not been received (S302:N), the overlay image generating unit 66 generates an overlay image 32 by overlaying the latest speech recognition result character string received by the character string receiving unit 62 on the captured image obtained in the processing in S301 (S303).

If it is confirmed that the confirmation flag has been received (S302:Y), the overlay image generating unit 66 generates an overlay image 32 by overlaying the latest speech recognition result character string and the latest translation result character string received by the character string receiving unit 62 on the captured image obtained in the processing in S301 (S304).

Subsequently, the overlay image generating unit 66 outputs the overlay image 32 generated by the processing shown in S303 or S304 to the video conference client unit 68 (S305), and the processing returns to S301.

In the present embodiment, a displayable area in a captured image may be set by the user. For example, the displayable area may be selected from the upper section, the lower section, and the entire section, for example. Further, the displayable area of the speech recognition result character string and the displayable area of the translation result character string may be set separately. For example, FIGS. 4 and 6 show an example of the video conference screen 30 in which the lower section is set as the displayable area of the speech recognition result character string. FIG. 6 shows an example of the video conference screen 30 in which the entire section is set as the displayable area of the translation result character string. In the present embodiment, a character string of a language having no space between words, such as Japanese, may start a new line at a predetermined number of characters. Further, a character string of a language having a space between words, such as English, may be set such that word wrap processing is executed at a predetermined number of characters.

In order to enhance readability, the character size of the translation result string may be larger than the character size of the speech recognition result string.

In the present embodiment, both of the translation result character string and the speech recognition result character string need not be overlaid on the captured image. For example, when the translation result character string is overlaid on the captured image, the speech recognition result character string may not be overlaid on the captured image.

In the present embodiment, the size of the speech recognition result character string may be fixed, and the size of the translation result character string may be variable.

In this case, the maximum size of a character included in the translation result string may be a size multiplied by a predetermined ratio to the height of the screen. As the number of characters per line increases, the character size of the translation result string may be reduced.

The character size of the speech recognition result character string may be variable. The character size of the translation result string may be fixed.

In the present embodiment, the number of displayable characters corresponding to the size of displayable area may be determined in advance. If a speech recognition result character string having the number of characters larger than the number of displayable characters is overlaid on the captured image, the speech recognition result character string may be reduced so as to fit in the height of the displayable area and then overlaid on the captured image. Further, if a translation result character string having the number of characters larger than the number of displayable characters is overlaid on the captured image, the translation result character string may be reduced so as to fit in the height of the displayable area and then overlaid on the captured image.

In the present embodiment, when the reception of packets of speech data by the input relay unit 80 has been interrupted for a predetermined time (e.g., 1.5 seconds), the character string relay unit 84 may control the translation of the speech indicated by the speech data received so far to be started. For example, when the reception of a packet of the speech data by the input relay unit 80 has been interrupted for a predetermined time (for example, 1.5 seconds), the character string relay unit 84 of the relay device 14 may in response transmit, to the translation unit 92 of the speech processing system 16, the speech recognition character string representing the speech recognition result of the speech indicated by the speech data received so far since the terminal 10 is connected to the relay device 14.

A list (log) of the speech recognition result character strings and the translation result character strings may be displayed on a screen (e.g., browser) different from the video conference screen 30. Such a log may be stored in a storage medium, such as the storage unit 12b, of the client device 12. Further, the browser may display the translation result character string obtained by translating the speech recognition result character string into a language different from the post-translation language described above.

The functions of the terminal 10 of the video conference translating system 1 may be implemented in the client device 12.

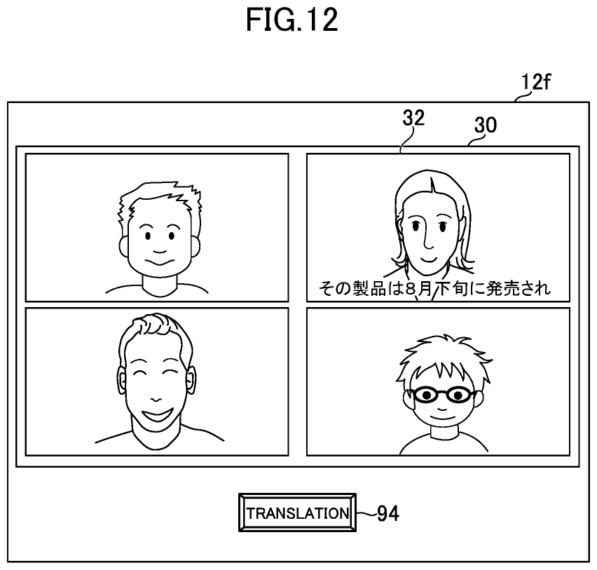

For example, as shown in FIG. 12, the client device 12 may have a function of displaying a translation button 94 on the display 12f. The translation button 94 may be displayed on the display 12f in addition to the video conference screen 30. For example, each time the speaker performs a predetermined operation, such as a click operation, on the translation button 94, the input-on state and input-off state described above may be switched in the client device 12. The speech recognition result character string and the translation result character string of the speech entered during the input-on state may be displayed on the video conference screen 30.

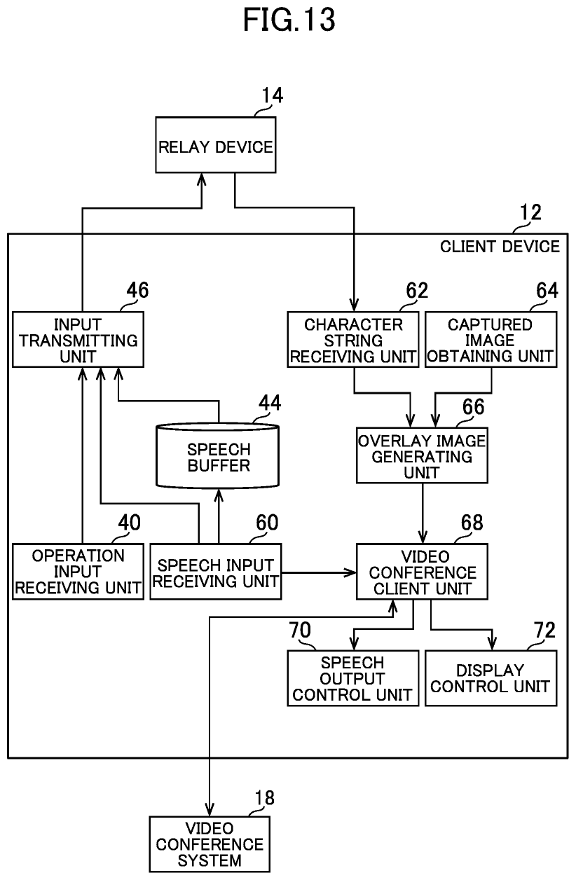

FIG. 13 is a functional block diagram showing an example of functions implemented in the client device 12 according to a modification of the embodiment described referring to FIGS. 1 to 11. In the client device 12 according to the present embodiment, all of the functions shown in FIG. 13 need not be implemented, and functions other than the functions shown in FIG. 13 may be implemented.

As shown in FIG. 13, the client device 12 according to the modification functionally includes, for example, an operation input receiving unit 40, a speech buffer 44, an input transmitting unit 46, a speech input receiving unit 60, a character string receiving unit 62, a captured image obtaining unit 64, an overlay image generating unit 66, a video conference client unit 68, a speech output control unit 70, and a display control unit 72. The operation input receiving unit 40 is implemented mainly by the processor 12a and the operation unit 12d. The speech buffers 44 is implemented mainly by the storage unit 12b. The input transmitting unit 46 and the character string receiving unit 62 are mainly implemented by the communication unit 12c. The speech input receiving unit 60 is implemented mainly by the processor 12a and the microphone 12g. The captured image obtaining unit 64 is implemented mainly by the processor 12a and the capturing unit 12e. The overlay image generating unit 66 is mainly implemented by the processor 12a. The video conference client unit 68 is implemented mainly by the processor 12a and the communication unit 12c. The speech output control unit 70 is implemented mainly by the processor 12a and a speaker 12h. The display control unit 72 is implemented mainly by the processor 12a and the display 12f.

The functions described above are implemented when the processor 12a executes a program that is installed in the client device 12, which is a computer, and includes commands corresponding to the above functions. The program is supplied to the client device 12 via a computer-readable information storage medium such as an optical disk, a magnetic disk, a magnetic tape, a magneto-optical disk, a flash memory, or via the Internet, for example.

For example, in this embodiment, the operation input receiving unit 40 displays the translating button 94 on the display 12f. For example, in this embodiment, the operation input receiving unit 40 receives an operation input, such as clicking on the translation button 94.

For example, in the present embodiment, the speech input receiving unit 60 receives the user's speech entered via the microphone 12g. The speech input receiving unit 60 outputs speech data indicating the entered speech to the video conference client unit 68.

For example, in this embodiment, the input transmitting unit 46 transmits a communication start request to the relay device 14 in response to the client device 12 changing from the input-off state to the input-on state. The speech data indicating the speech, which is entered via the microphone 12g during the period from the time when the client device 12 changes from the input-off state to the input-on state to the time when the communication between the relay device 14 and the terminal 10 is established, is not only output to the video conference client unit 68 but also stored in the speech buffer 44.

In response to the client device 12 changing from the input-on state to the input-off state, the input transmitting unit 46 transmits a confirmation request to the relay device 14.

The other functions of the speech buffer 44 and the input transmitting unit 46 are the same as those described above with reference to FIG. 8A, and thus the descriptions thereof will be omitted. Further, the functions of the character string receiving unit 62, the captured image obtaining unit 64, the overlay image generating unit 66, the video conference client unit 68, the speech output control unit 70, and the display control unit 72 are the same as those described above with reference to FIG. 8B, and thus the descriptions thereof will be omitted. In this modification, the relay device 14 does not transmit a character string to the terminal 10.

As in the examples shown in FIGS. 12 and 13, the input relay unit 80 may receive, from the client device 12, speech data indicating a speech entered by a speaker (a man or a woman who makes speech) in the client device 12. Further, the input relay unit 80 may receive a confirmation request that is transmitted from the client device 12 in response to a predetermined operation performed by the speaker to the client device 12.

The display control unit 72 may control the display 12f of the client device 12 to display a screen including an image obtained by overlaying the character string representing the translation result of the speech indicated by the speech data received before the reception of the confirmation request on the image captured by the capturing unit 12e.

In the present embodiment, a plurality of languages may be set as the post-translation languages. The character string relay unit 84 may control the translation of the speech indicated by the speech data received before the reception of the confirmation request into the set languages to be started. In this case, for example, the character string relay unit 84 may transmit the speech recognition character string to the plurality of translation units 92 respectively associated with the post-translation languages.

The display control unit 72 may control the display 12f to display a screen including an image obtained by overlaying a translation result character strings for each of the set languages on the captured image.

For example, a translation result character string obtained by translating a speech recognition result character string into English may be displayed in the lower section of the captured image, and a translation result character string obtained by translating the speech recognition result character string into Chinese may be displayed in the upper section of the captured image.

These translation result strings may disappear from the screen in response to a confirmation that the translation result strings for all the post-translation languages have been displayed.

The present invention is not limited to the embodiment described above.

For example, the roles of the terminal 10, the client device 12, the relay device 14, the speech processing system 16, and the video conference system 18 are not limited to those described above. For example, the translation processing for a speech recognition result character string may be executed in the speech processing system 16 without through the relay device 14.

For example, the client device 12 may receive speech data, which is transmitted from the terminal 10 to the relay device 14, from the relay device 14. The client device 12 may output the speech data received from the relay device 14 to the video conference system 18, instead of the speech data indicating the speech entered from the microphone 12g.

The specific character strings and numerical values described above, and specific character strings and numerical values in the drawings are illustrative only, and are not limited to these character strings and numerical values.

What is claimed is:

1. A display control system, comprising:
at least one processor; and
at least one memory device storing instructions which, when executed by the at least one processor, cause the at least one processor to perform operations comprising:
receiving speech data indicating a speech entered by a speaker;
receiving a confirmation request that is output in response to a predetermined operation of the speaker;
controlling translation of the speech indicated by the speech data to be started in response to a reception of the confirmation request, the speech data having been received before the reception of the confirmation request; and
controlling a display unit to display a screen including an image obtained by overlaying a character string on an image captured by a capturing unit, the character string representing a translation result of the speech indicated by the speech data that has been received before the reception of the confirmation request.

2. The display control system according to claim 1, wherein the operations further comprise controlling the display unit to display, before the reception of the confirmation request, a screen including an image obtained by overlaying a character string on an image captured by the capturing unit, the character string representing a speech recognition result of the speech indicated by the received speech data.

3. The display control system according to claim 1, wherein
controlling the display unit comprises displaying a screen including an image obtained by overlaying both of a character string representing a speech recognition result of a speech indicated by the speech data that has been received before the reception of the confirmation request, and a character string representing a translation result of the speech indicated by the speech data that has been received before the reception of the confirmation request on an image captured by the capturing unit.

4. The display control system according to claim 1, wherein the operations further comprise outputting an image obtained by overlaying a character string on an image captured by the capturing unit, to a video conference system, and wherein
controlling the display unit comprises displaying the screen generated by the video conference system.

5. The display control system according to claim 1, wherein:
the received speech data indicates a speech from a terminal, the speech being entered in the terminal by the speaker,
the confirmation request is transmitted from the terminal in response to a predetermined operation performed on the terminal by the speaker,
controlling the display unit comprises controlling the display unit of a client device to display a screen including an image obtained by overlaying a character string on an image captured by the capturing unit, the character string representing a translation result of a speech indicated by the speech data that has been received before the reception of the confirmation request, and
the operations further comprise controlling a display unit of the terminal to display a character string representing a translation result of the speech indicated by the speech data that has been received before the reception of the confirmation request.

6. The display control system according to claim 1, wherein
the received speech data indicates a speech from a client device, the speech being entered in the client device by the speaker,
the confirmation request is transmitted from the client device in response to a predetermined operation performed on the client device by the speaker, and
controlling the display unit comprises controlling the display unit of the client device to display a screen including an image obtained by overlaying a character string on an image captured by the capturing unit, the character string representing a translation result of a speech indicated by the speech data that has been received before the reception of the confirmation request.

7. The display control system according to claim 1, wherein
controlling the translation comprises controlling translation of a speech indicated by the speech data into a plurality of languages to be started, the speech data having been received before the reception of the confirmation request, and
controlling the display comprises controlling the display unit to display a screen including an image obtained by overlaying character strings on an image captured by the capturing unit, the character strings representing translation results of the speech indicated by the speech data in the plurality of languages.

8. A display control method, comprising:
receiving speech data indicating a speech entered by a speaker;
receiving a confirmation request that is output in response to a predetermined operation of the speaker;
controlling translation of the speech indicated by the speech data to be started in response to a reception of the confirmation request, the speech data having been received before the reception of the confirmation request; and
controlling a display unit to display a screen including an image obtained by overlaying a character string on an image captured by a capturing unit, the character string representing a translation result of the speech indicated by the speech data that has been received before the reception of the confirmation request.

9. A non-transitory computer readable information storage medium storing a program for causing a computer to execute:
receiving speech data indicating a speech entered by a speaker;
receiving a confirmation request that is output in response to a predetermined operation of the speaker;
controlling translation of the speech indicated by the speech data to be started in response to a reception of the confirmation request, the speech data having been received before the reception of the confirmation request; and
controlling a display unit to display a screen including an image obtained by overlaying a character string on an image captured by a capturing unit, the character string representing a translation result of the speech indicated by the speech data that has been received before the reception of the confirmation request.
